(19) United States
(12) Patent Application Publication
(10) Pub. No.: US 2018/0361549 A1
(43) Pub. Date: Dec. 20, 2018

(54) JAW FOR PROPRESS FITTING

(71) Applicant: Kwon J. PARK, Diamond Bar, CA (US)

(72) Inventor: Kwon J. PARK, Diamond Bar, CA (US)

(21) Appl. No.: 15/624,672

(22) Filed: Jun. 15, 2017

(51) Int. Cl. B25B 27/10

(52) U.S. Cl. CPC B25B 27/10

(57) ABSTRACT

A jaw for a propress fitting system is provided, comprising first and second members, an axle portion, two front and rear jaw plates. The first member has a first arm portion and a first jaw portion, and the second member has a second arm portion and a second jaw portion. The axle portion rotatably engages with the first member and second members through axle holes, and each of the axle holes is provided through a middle portion between the first or second arm portion and the first or second jaw portion. Each of the two front jaw plates is disposed and fixed on a front surface of the first or second jaw portion. An outer diameter of the first and second jaw portions is smaller than an outer width between the first and second arm portions, so that the jaw be deployed around a pipe in a crowded space.

### BACKGROUND OF THE INVENTION

The present invention relates to a jaw for propress fitting.

Propress fitting or PEX fitting is essential in tubing works, which cannot be compared to conventional thread-fitting, for example, in the speed and reliability of work.

However, sometimes the circumstances may be challenging to apply the propress fitting or PEX fitting, especially in a crowded space, which is not rare situations in the world of plumbers.

The conventional devices or system of propress fitting have issues and defects to solve, so as to be applied widely in some challenging situations.

Accordingly, a need for a jaw for propress fitting has been present for a long time considering the expansive demands in the everyday life. This invention is directed to solve these problems and satisfy the long-felt need.

### SUMMARY OF THE INVENTION

The present invention contrives to solve the disadvantages of the prior art.

An object of the invention is to provide a jaw for propress fitting, especially in a crowded work space.

Another object of the invention is to provide an improvement that can be applied easily to a conventional jaw for propress fitting.

Still another object of the invention is to provide a propress fitting system with an improved structure that can be applied easily to a conventional jaw for propress fitting.

An aspect of the invention provides a jaw for a propress fitting system, comprising a first member, a second member, an axle portion, two front jaw plates, and two rear jaw plates.

The first member has a first arm portion and a first jaw portion formed integrally with the first arm portion, and the second member has a second arm portion and a second jaw portion formed integrally with the second arm portion.

The axle portion rotatably engages with the first member and the second member through axle holes, and each of the axle holes is provided through a middle portion between the first or second arm portion and the first or second jaw portion, so that the first and second jaw portions are pressed toward each other as the first and second arm portions are opened outwards away from each other by the propress fitting system.

Each of the two front jaw plates is disposed and fixed on a front surface of the first or second jaw portion, and each of the two rear jaw plates is disposed and fixed on a rear surface of the first or second jaw portion.

An outer diameter of the first and second jaw portions is substantially smaller than an outer width between the first and second arm portions, so that the first and second jaw portions are deployed around an external pipe in a crowded space.

The two front and two rear jaw plates are configured to strengthen the first and second jaw portions.

A front pressing diameter formed by the front jaw plates is larger than a rear pressing diameter formed by the rear jaw plates.

Each of the two front and two rear jaw plates may have a predetermined thickness, a predetermined inner diameter, and a predetermined outer diameter.

The first and second jaw portions may form a central pressing diameter, and the central pressing diameter may be smaller than the front pressing diameter or the rear pressing diameter.

The central pressing diameter may be configured for being predetermined by a diameter of the external pipe, and each of the front and rear pressing diameters may be configured for being predetermined by diameters of other external appendages to the external pipe in the vicinity of the propressing spot.

Each of the two front jaw plates and the two rear jaw plates may have a hardness substantially higher than the first and second jaw portions.

A width of each of the first and second jaw portions may be approximately as large as a radius of the central pressing diameter.

Each of the two front jaw plates and the two rear jaw plates may be formed integrally with a corresponding first or second jaw portions.

Each of the two front jaw plates and the two rear jaw plates may be hardened by heat treatment.

The jaw may further comprise a first shoulder portion and a second shoulder portion.

The first shoulder portion is disposed between the first jaw portion and the first arm portion, and the second shoulder portion is disposed between the first jaw portion and the first arm portion.

Each of the first and second shoulder portions has an open angle larger than 90 degrees.

Another aspect of the invention provides a jaw for a propress fitting system, comprising first and second member, and an axle portion.

The first member has a first arm portion and a first jaw portion formed integrally with the first arm portion, and the second member has a second arm portion and a second jaw portion formed integrally with the second arm portion.

The axle portion rotatably engages with the first member and the second member through axle holes, each of which being provided through a middle portion between the first or second arm portion and the first or second jaw portion, so that the first and second jaw portions are pressed toward each other as the first and second arm portions are opened outwards away from each other by the propress fitting system.

A width between the first and second jaw portions is smaller than a width between the first and second arm portions, so that the first and second jaw portions are deployed around an external pipe in a crowded space.

Each of the first and second jaw portions has a thickness larger than each of the first and second arm portions.

The first and second jaw portions form a central pressing diameter at a central cross-section, a front pressing diameter at a front cross-section, and a rear pressing diameter at a rear cross-section.

Each of the front and rear pressing diameter is larger than the central pressing diameter, and the front pressing diameter is larger than the rear pressing diameter.

An outer diameter of each of the first and second jaw portions may be substantially smaller than an outer width of each of the first and second arm portions.

A width of each of the first and second jaw portions may be approximately as large as a radius of the central pressing diameter.

The jaw may further comprise first and second shoulder portions.

The first shoulder portion is disposed between the first jaw portion and the first arm portion, and the second shoulder portion is disposed between the first jaw portion and the first arm portion.

Each of the first and second shoulder portions has an open angle larger than 90 degrees.

The advantages of the present invention are: (1) the jaw for propress fitting system can be applied to conventional system easily; and (2) the jaw for propress fitting system according to the invention enables to apply the system in a very crowded environment.

Although the present invention is briefly summarized, the fuller understanding of the invention can be obtained by the following drawings, detailed description and appended claims.

### BRIEF DESCRIPTION OF THE DRAWINGS

These and other features, aspects and advantages of the present invention will become better understood with reference to the accompanying drawings, wherein:

FIG. 1 is a perspective view showing a propress fitting system with a jaw installed according to a prior art;

FIG. 2 is a perspective view showing a conventional jaw;

FIG. 3 is a perspective view showing a copper pipe with a propressing spot;

FIG. 4 is a perspective view showing an inside of copper pipe;

FIG. 5 is a perspective view of a jaw according to an embodiment of the invention;

FIG. 6 is another perspective view of the jaw of FIG. 5;

FIG. 7 is still another perspective view of the jaw of FIG. 5;

FIG. 8 is a perspective view of the jaw according to another embodiment of the invention;

FIG. 9 is a perspective view showing a jaw deployed around an external pipe according to an embodiment of the invention; and

FIG. 10 is another perspective view showing a jaw deployed around an external pipe according to an embodiment of the invention.

### DETAILED DESCRIPTION EMBODIMENTS OF THE INVENTION

Referring to the figures, the embodiments of the invention are described in detail.

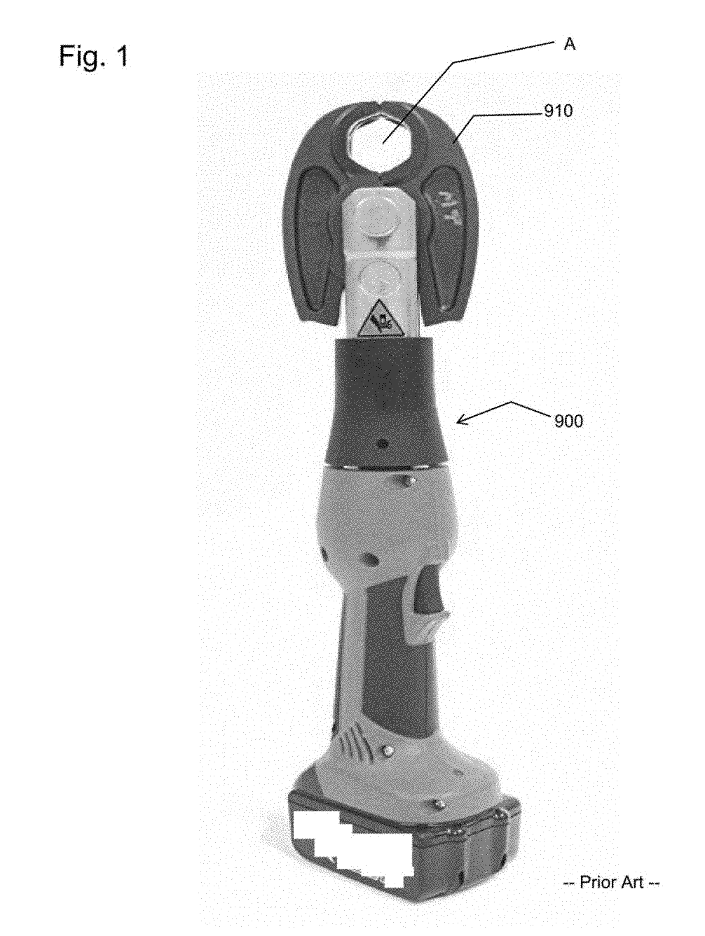

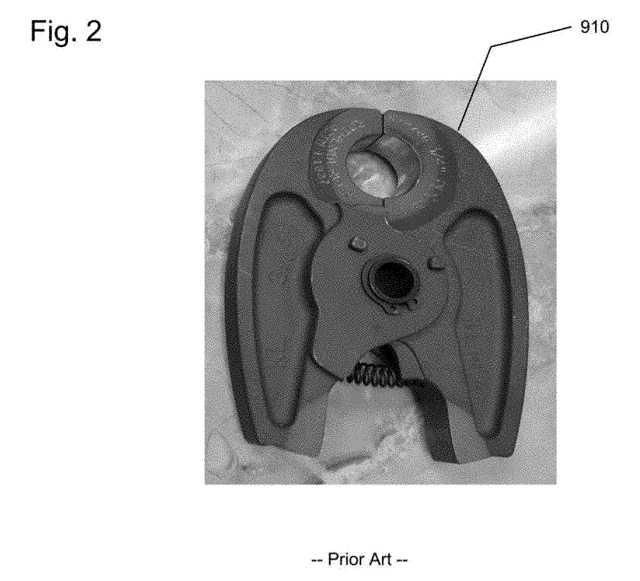

ProPress is a series of products based on copper pressed fittings. These fittings do not require sweating copper pipe with tin and lead solder. The general look of a propress fitting system is shown in FIGS. 1 and 2.

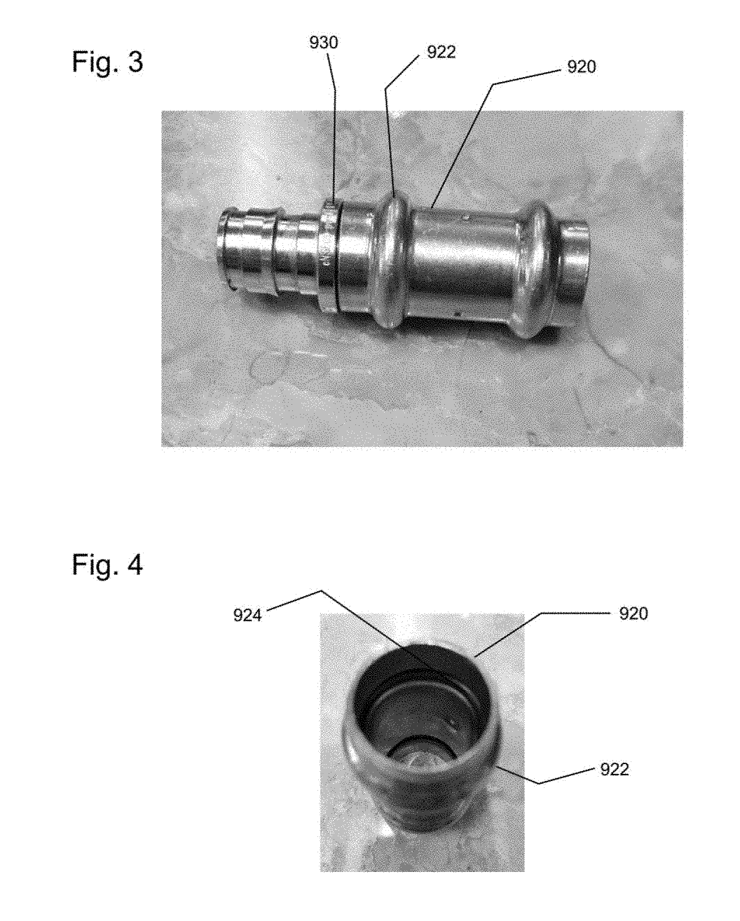

As shown in FIG. 1, a jaw (910) is installed in a propress fitting system (900). As well known to the community, the propress fitting system (900) is usually powered by motor and battery system, pressing on a pipe (not shown), such as one in FIGS. 3 and 4, disposed through the circular hole formed by the jaw (910). The pipe (920) is connected with the part (930), by the portion (922) is pressed on the part (930) with an O-ring (924) in between.

The shape of a jaw (100) for PEX fitting is more or less the same as those for copper press fitting illustrated in the attached drawings. Therefore, all the inventive features of the present invention may be applied to PEX fitting.

An object of the invention is to provide a jaw for propress fitting system, especially in a crowded work space.

Another object of the invention is to provide an improvement that can be applied easily to a conventional jaw for propress fitting system.

Still another object of the invention is to provide a propress fitting system with an improved structure that can be applied easily to a conventional jaw for propress fitting system.

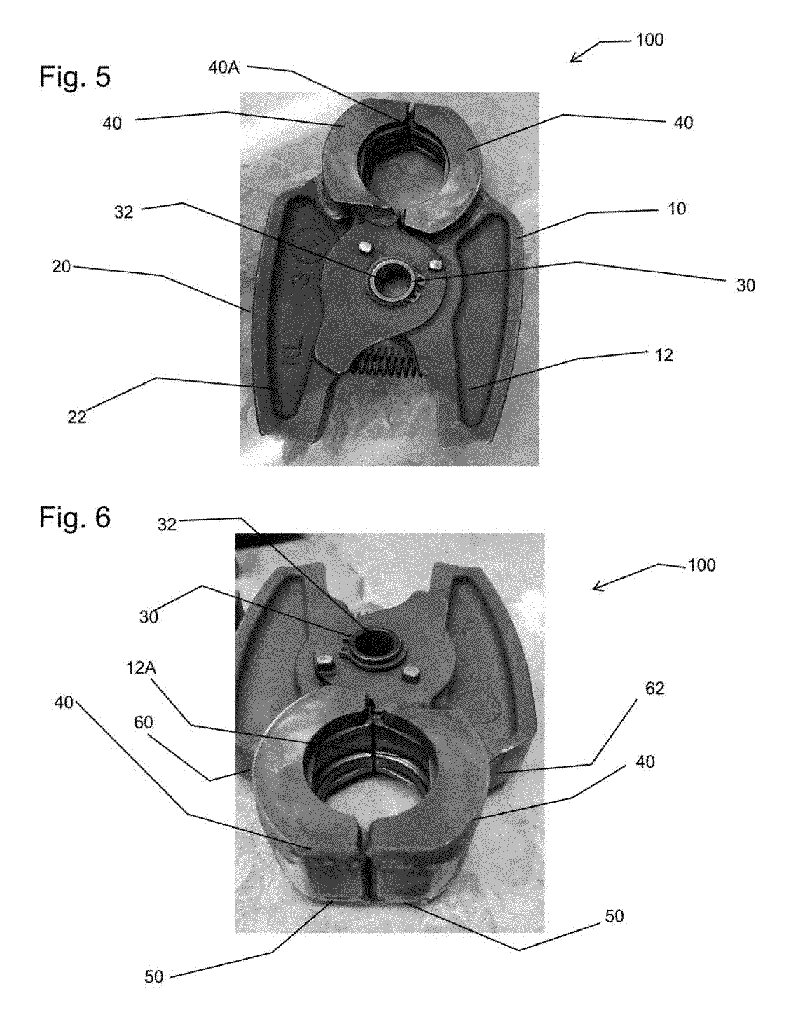

As shown in FIGS. 5-7, 9, and 10, an aspect of the invention provides a jaw (100) for a propress fitting system as shown in FIG. 1, comprising a first member (10), a second member (20), an axle portion (30), two front jaw plates (40), and two rear jaw plates (50).

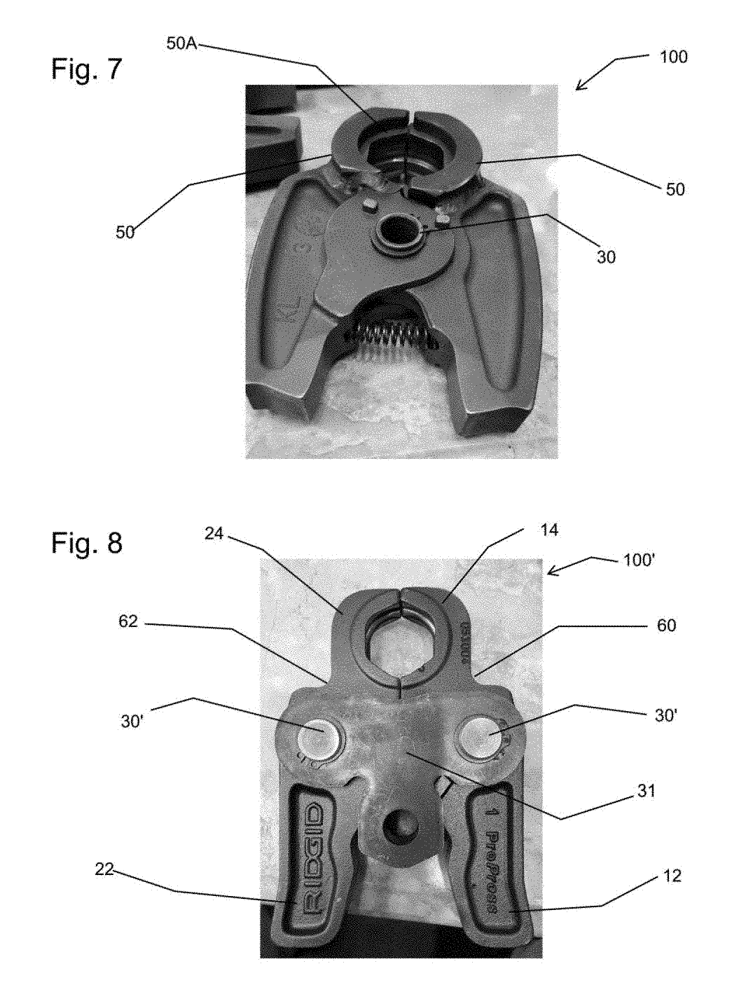

The first member (10) has a first arm portion (12) and a first jaw portion (14) formed integrally with the first arm portion (12), and the second member (20) has a second arm portion (22) and a second jaw portion (24) formed integrally with the second arm portion (22) as shown in FIGS. 7 and 8, for example.

The axle portion (30) rotatably engages with the first member (10) and the second member (10) through axle holes (32), and each of the axle holes (32) is provided through a middle portion between the first or second arm portion (12, 22) and the first or second jaw portion (14, 24), so that the first and second jaw portions (14, 24) are pressed toward each other as the first and second arm portions (12, 22) are opened outwards away from each other by the propress fitting system (100).

In certain embodiments of the invention, the axle portion (30) may be replaced two axle portions (30′) and an axle plate (31) securing the two axle portions (30′) as shown in FIG. 8. Actually, any structure can be applicable as long as the jaw portions (14, 24) can be clamped together by pushing the arm portions (12, 22) outwards.

Each of the two front jaw plates (40) is disposed and fixed on a front surface of the first or second jaw portion (14, 24), and each of the two rear jaw plates (50) is disposed and fixed on a rear surface of the first or second jaw portion (14, 24) as shown in FIGS. 5-7.

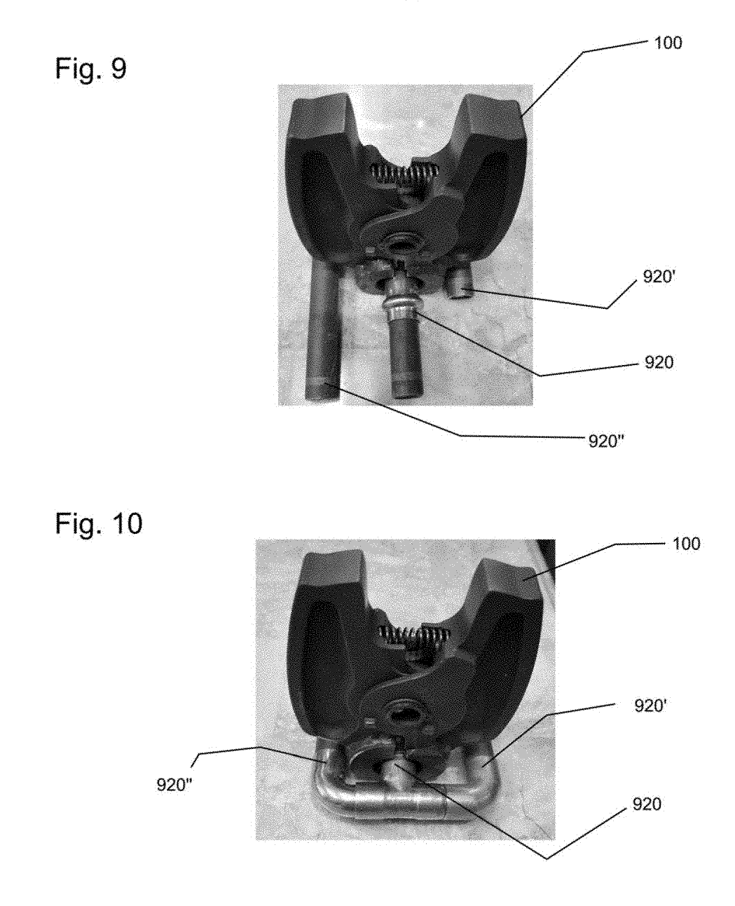

An outer diameter of the first and second jaw portions (14, 24) is substantially smaller than an outer width between the first and second arm portions (12, 22), so that the first and second jaw portions (14, 24) are deployed around external pipes (920′, 920″) in a crowded space, as shown in FIGS. 9 and 10.

The two front and two rear jaw plates (40, 50) are configured to strengthen the first and second jaw portions (14, 24).

A front pressing diameter (40A) formed by the front jaw plates (40) is larger than a rear pressing diameter (50A) formed by the rear jaw plates (50) as shown in FIGS. 5 and 7.

Each of the two front and two rear jaw plates (40, 50) may have a predetermined thickness, a predetermined inner diameter, and a predetermined outer diameter as illustrated.

The first and second jaw portions (14, 24) may form a central pressing diameter (12A), and the central pressing diameter may be smaller than the front pressing diameter (40A) or the rear pressing diameter (50A) as shown in FIGS. 5-7.

The central pressing diameter (12A) may be configured for being predetermined by a diameter of the external pipe (920), and each of the front and rear pressing diameters (40A, 50A) may be configured for being predetermined by diameters of other external appendages (920′, 920″) to the external pipe (920) in the vicinity of the propressing spot as shown in FIGS. 3-4 and FIGS. 9-10.

Each of the two front jaw plates (40) and the two rear jaw plates (50) may have a hardness substantially higher than the first and second jaw portions (14, 24).

A width of each of the first and second jaw portions (14, 24) may be approximately as large as a radius of the central pressing diameter (12A) as shown in FIGS. 5-8. Therefore the jaw (100) can be used in a really crowded space as shown in FIGS. 9-10.

Each of the two front jaw plates and the two rear jaw plates (40, 50) may be formed integrally with a corresponding first or second jaw portions (14, 24). Of course, as illustrated, each of the two front jaw plates and the two rear jaw plates (40, 50) may be welded a corresponding first or second jaw portions (14, 24).

Each of the two front jaw plates and the two rear jaw plates (40, 50) may be hardened by heat treatment. The main purpose of the two front jaw plates and the two rear jaw plates (40, 50) is to strengthen the first and second jaw portions (14, 24).

The jaw (100) may further comprise a first shoulder portion (60) and a second shoulder portion (62) as shown in FIG. 8.

The first shoulder portion (60) is disposed between the first jaw portion (14) and the first arm portion (12), and the second shoulder portion (62) is disposed between the first jaw portion (24) and the first arm portion (22) as shown in FIGS. 6 and 8.

Each of the first and second shoulder portions (60, 62) has an open angle same as or larger than 90 degrees as shown in FIGS. 6 and 8.

Another aspect of the invention provides a jaw (100) for a propress fitting system, comprising first and second member, and an axle portion. That is, in the jaw (100) according to this embodiment, the front and rear jaw plates (40, 50) can be considered to be formed integrally with corresponding jaw portions (14, 24).

The rest is same as in the above, as follows.

The first member has a first arm portion and a first jaw portion formed integrally with the first arm portion, and the second member has a second arm portion and a second jaw portion formed integrally with the second arm portion.

The axle portion rotatably engages with the first member and the second member through axle holes, each of which being provided through a middle portion between the first or second arm portion and the first or second jaw portion, so that the first and second jaw portions are pressed toward each other as the first and second arm portions are opened outwards away from each other by the propress fitting system.

A width between the first and second jaw portions is smaller than a width between the first and second arm portions, so that the first and second jaw portions are deployed around an external pipe in a crowded space.

Each of the first and second jaw portions has a thickness larger than each of the first and second arm portions.

The first and second jaw portions form a central pressing diameter at a central cross-section, a front pressing diameter at a front cross-section, and a rear pressing diameter at a rear cross-section.

Each of the front and rear pressing diameter is larger than the central pressing diameter, and the front pressing diameter is larger than the rear pressing diameter.

An outer diameter of each of the first and second jaw portions may be substantially smaller than an outer width of each of the first and second arm portions.

A width of each of the first and second jaw portions may be approximately as large as a radius of the central pressing diameter.

The jaw may further comprise first and second shoulder portions.

The first shoulder portion is disposed between the first jaw portion and the first arm portion, and the second shoulder portion is disposed between the first jaw portion and the first arm portion.

Each of the first and second shoulder portions has an open angle same as or larger than 90 degrees.

Also, in still another embodiment of the invention, the jaw portions (14, 24) can be made of stronger material, so that the thickness of the jaw portions (14, 24) is as same as the arm portions (12, 22). Still, the jaw (100′) as shown in FIG. 8 comprises the shoulder portions (60, 62), so that it can be used in a crowded environment as shown in FIGS. 9 and 10.

While the invention has been shown and described with reference to different embodiments thereof, it will be appreciated by those skilled in the art that variations in form, detail, compositions and operation may be made without departing from the spirit and scope of the invention as defined by the accompanying claims.

What is claimed is:

1. A jaw for a propress fitting system, the jaw comprising:
a first member having a first arm portion and a first jaw portion formed integrally with the first arm portion;
a second member having a second arm portion and a second jaw portion formed integrally with the second arm portion;
an axle portion rotatably engaging with the first member and the second member through axle holes, each of which being provided through a middle portion between the first or second arm portion and the first or second jaw portion, so that the first and second jaw portions are pressed toward each other as the first and second arm portions are opened outwards away from each other by the propress fitting system;
two front jaw plates, each of which being disposed and fixed on a front surface of the first or second jaw portion; and
two rear jaw plates, each of which being disposed and fixed on a rear surface of the first or second jaw portion,
wherein an outer diameter of the first and second jaw portions is substantially smaller than an outer width between the first and second arm portions, so that the first and second jaw portions are deployed around an external pipe in a crowded space,
wherein the two front and two rear jaw plates are configured to strengthen the first and second jaw portions, and
wherein a front pressing diameter formed by the front jaw plates is larger than a rear pressing diameter formed by the rear jaw plates.

2. The jaw of claim 1, wherein each of the two front and two rear jaw plates has a predetermined thickness, a predetermined inner diameter, and a predetermined outer diameter.

3. The jaw of claim 2, wherein the first and second jaw portions form a central pressing diameter, and wherein the central pressing diameter is smaller than the front pressing diameter or the rear pressing diameter.

4. The jaw of claim 3, wherein the central pressing diameter is configured for being predetermined by a diameter of the external pipe, and wherein each of the front and rear pressing diameters are configured for being predetermined by diameters of other external appendages to the external pipe in the vicinity of the propressing spot.

5. The jaw of claim 1, wherein each of the two front jaw plates and the two rear jaw plates has a hardness substantially higher than the first and second jaw portions.

6. The jaw of claim 5, wherein a width of each of the first and second jaw portions is approximately as large as a radius of the central pressing diameter.

7. The jaw of claim 1, wherein each of the two front jaw plates and the two rear jaw plates is formed integrally with a corresponding first or second jaw portions.

8. The jaw of claim 7, wherein each of the two front jaw plates and the two rear jaw plates is hardened by heat treatment.

9. The jaw of claim 1, further comprising:
a first shoulder portion disposed between the first jaw portion and the first arm portion; and
a second shoulder portion disposed between the first jaw portion and the first arm portion,
wherein each of the first and second shoulder portions has an open angle same or larger than 90 degrees.

10. A jaw for a propress fitting system, the jaw comprising:
a first member having a first arm portion and a first jaw portion formed integrally with the first arm portion;
a second member having a second arm portion and a second jaw portion formed integrally with the second arm portion;
an axle portion rotatably engaging with the first member and the second member through axle holes, each of which being provided through a middle portion between the first or second arm portion and the first or second jaw portion, so that the first and second jaw portions are pressed toward each other as the first and second arm portions are opened outwards away from each other by the propress fitting system;
wherein a width between the first and second jaw portions is smaller than a width between the first and second arm portions, so that the first and second jaw portions are deployed around an external pipe in a crowded space,
wherein each of the first and second jaw portions has a thickness larger than each of the first and second arm portions,
wherein the first and second jaw portions form a central pressing diameter at a central cross-section, a front pressing diameter at a front cross-section, and a rear pressing diameter at a rear cross-section, and
wherein each of the front and rear pressing diameter is larger than the central pressing diameter, and the front pressing diameter is larger than the rear pressing diameter.

11. The jaw of claim 10, wherein an outer diameter of each of the first and second jaw portions is substantially smaller than an outer width of each of the first and second arm portions.

12. The jaw of claim 11, wherein a width of each of the first and second jaw portions is approximately as large as a radius of the central pressing diameter.

13. The jaw of claim 11, further comprising:
a first shoulder portion disposed between the first jaw portion and the first arm portion; and
a second shoulder portion disposed between the first jaw portion and the first arm portion,
wherein each of the first and second shoulder portions has an open angle same as or larger than 90 degrees.
